(19) United States
(12) Patent Application Publication
(10) Pub. No.: US 2008/0074600 A1
(43) Pub. Date: Mar. 27, 2008

(54) LIQUID CRYSTAL DISPLAY APPARATUS

(75) Inventors: Che-Ming HSU, Tainan (TW); Chien-Hong CHEN, Tainan (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 11/860,304

(22) Filed: Sep. 24, 2007

(30) Foreign Application Priority Data
Sep. 25, 2006 (TW) 95135443

(51) Int. Cl. G02F 1/1343

(52) U.S. Cl. 349/143

(57) ABSTRACT

A liquid crystal display (LCD) apparatus includes a first substrate, a second substrate, a liquid crystal (LC) layer, a common electrode and a pixel electrode. The first substrate is disposed opposite to the second substrate, and the LC layer is disposed between the first substrate and the second substrate. The common electrode is disposed between the first substrate and the LC layer and is formed with at least one first jagged pattern having a first main slit and a plurality of first fine slits disposed at both sides of the first main slit. A sum of a width of each of the first fine slits and an interval between the adjacent first fine slits is greater than or equal to 3 microns and smaller than 7 microns. The pixel electrode is disposed between the second substrate and the LC layer and is located opposite to the common electrode.

### CROSS REFERENCE TO RELATED APPLICATIONS

This Non-provisional application claims priority under 35 U.S.C. §119(a) on Patent Application No(s). 095135443 filed in Taiwan, Republic of China on Sep. 25, 2006, the entire contents of which are hereby incorporated by reference.

### BACKGROUND OF THE INVENTION

1. Field of Invention

The invention relates to a liquid crystal display (LCD) apparatus and, in particular, to a multi-domain vertical aligned mode (MVA) LCD apparatus.

2. Related Art

With the coming of the digital age, the technology of LCD apparatuses also grows rapidly and the LCD apparatuses have become one of the indispensable electronic products. Correspondingly, the technological and functional requirements of the LCD apparatus has become higher and higher. More specifically, the LCD apparatus having the light, thin, short and small properties have played a relatively important role. Currently, the LCD apparatus has been widely applied to various electronic products such as the mobile phone, personal digital assistant (PDA) and notebook computer, and shortening a response time of a liquid crystal molecule has become an important technological factor of the LCD apparatus.

Most LCD apparatuses have the problems that view angles thereof are not sufficiently wide, so a multi-domain vertical aligned mode (MVA) LCD apparatus with the increased view angle is frequently used. The LCD apparatus is made of a negative liquid crystal material and uses a vertical aligned film. When no voltage is supplied, the liquid crystal molecules are arranged in a vertical direction so that the incident light beam cannot penetrate through the LCD apparatus. Accordingly, a black display appears. When an external voltage is applied, the liquid crystal molecules are arranged in a horizontal direction so that the incident light beam can penetrate through the LCD apparatus. Accordingly, a white display appears. The LCD apparatus has improved the drawback of the insufficiently wide view angle by setting the orientations of the liquid crystal molecules to a plurality of different directions.

Referring to FIG. 1, a conventional LCD apparatus 1 includes a first substrate 11, a color filter layer 12, a common electrode 13, a liquid crystal (LC) layer 14, a pixel electrode 15 and a second substrate 16 stacked in order. The common electrode 13 is provided with a plurality of protrusions 17, and the pixel electrode 15 is formed with a plurality of slits 151. The protrusions 17 and the slits 151 are interleaved, and arranging directions of the liquid crystal molecules are determined according to the fringe-field effect generated by the pattern of the protrusions 17 and the slits 151. When an external voltage is applied, the liquid crystal molecules of the LC layer 14 are arranged in different specific directions under the influence of the fringe-field effect of the protrusions 17 and the slits 151 so that the view angle of the LCD apparatus 1 is improved.

Although the above-mentioned problem of the view angle is improved, the fringe-field effect subjected to the liquid crystal molecule, which is farther from the protrusion 17 and the slit 151, is weaker when the distance between the protrusion 17 and the slit 151 is increased. Thus, the liquid crystal molecule tilts to an arbitrary direction when being influenced by the voltage so that the tilt direction of the liquid crystal molecule cannot be controlled, thereby causing the disclination condition. In this case, it is necessary to spend time to wait for the liquid crystal molecule to retilt and thus to return to the correct angle. Thus, the response time of the liquid crystal molecule is lengthened.

When an instantaneous high voltage is applied, the liquid crystal molecule in the LC layer 14 sandwiched between the protrusion 17 and the slit 151 is influenced by the vertical electric field so that the liquid crystal molecules start to tilt before it is orientated under the tilts of the neighboring liquid crystal molecules. Furthermore, the tilt direction of the liquid crystal molecule is not controlled by the fringe-field effect because the liquid crystal molecule is farther from the protrusion 17 and the slit 151, so the disclination condition of the liquid crystal molecule is generated. A gray spot or a black spot is represented under an optical microscope.

In order to make the liquid crystal molecule with disclination be influenced by the neighboring liquid crystal molecules and thus return to the correct angle of the normal state, a longer period of time has to be spent to retilt and thus return to the correct angle, thereby lengthening the response time of the liquid crystal molecule. In addition, when the neighboring liquid crystal molecules cannot influence the liquid crystal molecule with disclination to return to the normal state, the liquid crystal molecule continues to represent the gray spot or black spot and thus cannot represent the desired brightness.

In addition, it is possible to reduce the interval between the protrusion 17 and the slit 151 to a predetermined level and thus to prevent the disclination condition from happening. However, if the interval between the protrusion 17 and the slit 151 is reduced, the numbers of the protrusions 17 and the slits 151 in one single pixel are increased. Because the protrusions 17 and the slits 151 deteriorate the penetrating ability of the light beam, the aperture ratio of the pixel is reduced and the brightness of the LCD apparatus 1 is further reduced.

As shown in FIG. 2, another conventional LCD apparatus 2 can improve the response time of the liquid crystal molecule. The LCD apparatus 2 includes a first substrate 21, a color filter layer 22, a common electrode 23, a LC layer 24, a pixel electrode 25 and a second substrate 26 stacked in order. The common electrode 23 has a plurality of protrusions 27, and the pixel electrode 25 has a jagged pattern 250. The liquid crystal molecules are arranged in different specific directions according to the influences of the protrusions 27 and the jagged pattern 250. Although the jagged pattern 250 can enhance the fringe-field effect, the disclination condition of the liquid crystal molecule still exists. Compared with the LCD apparatus 1, the response time of the liquid crystal molecule has been improved. However, the interval between the protrusion 27 and the jagged pattern 250 still has to be kept within a predetermined range so that the aperture ratio is still limited.

Therefore, it is an important subject to provide a LCD apparatus capable of shortening the response time of liquid crystal molecules.

### SUMMARY OF THE INVENTION

In view of the foregoing, the invention is to provide a LCD apparatus capable of shortening the response time of liquid crystal molecules.

To achieve the above, the invention discloses a liquid crystal display (LCD) apparatus, which includes a first substrate, a second substrate, a liquid crystal (LC) layer, a common electrode and a pixel electrode. The second substrate is disposed opposite to the first substrate. The LC layer is disposed between the first substrate and the second substrate. The common electrode is disposed between the first substrate and the LC layer and formed with at least one first jagged pattern. The first jagged pattern has a first main slit and a plurality of first fine slits disposed at both sides of the first main slit. A sum of a width of each of the first fine slits and an interval between adjacent two of the first fine slits is greater than or equal to 3 microns and smaller than 7 microns. The pixel electrode is disposed between the second substrate and the LC layer, and is located opposite to the common electrode.

To achieve the above, the invention also discloses a liquid crystal display (LCD) apparatus, which includes a first substrate, a second substrate, a liquid crystal (LC) layer, a common electrode and a pixel electrode. The second substrate is disposed opposite to the first substrate. The LC layer is disposed between the first substrate and the second substrate. The common electrode is disposed between the first substrate and the LC layer. The pixel electrode is disposed between the second substrate and the LC layer, and is located opposite to the common electrode. Herein, the pixel electrode is formed with at least one third jagged pattern having a third main slit and a plurality of third fine slits disposed at both sides of the third main slit. A sum of a width of each of the third fine slits and an interval between adjacent two of the third fine slits is greater than or equal to 3 microns and smaller than 7 microns.

As mentioned above, the LCD apparatus of the invention has the jagged pattern formed on the common electrode or the pixel electrode, and the jagged pattern has a main slit and a plurality of fine slits disposed at both sides of the main slit. Furthermore, the sum (fine slit period) of the width of each fine slit and the interval between the adjacent fine slits is greater than or equal to 3 microns and smaller than 7 microns. Compared with the related art, the LCD apparatus of the invention has the jagged pattern formed on the common electrode or the pixel electrode. The response time of the liquid crystal molecule gets shorter as the value of the fine slit period gets smaller. If the value of the interval between the fine slit and its adjacent fine slit is decreased, the response time of the liquid crystal molecule can be greatly shortened, and the fringe-field effects of the liquid crystal molecules corresponding to the fine slits of the first substrate and the second substrate farther from the main slits of the first substrate and the second substrate can be increased. Thus, when a voltage is applied, the tilt direction of the liquid crystal molecule can be easily controlled, and it is also possible to prevent the disclination of the liquid crystal molecule from happening. In addition, the fine slits on the first substrate and the second substrate can match with each other, so the fringe-field effects can be increased. Consequently, the interval between the main slits can be increased to increase the ratio of the light-permeable region, to increase the aperture ratio and thus to enhance the quality of the LCD apparatus.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration showing a conventional LCD apparatus;

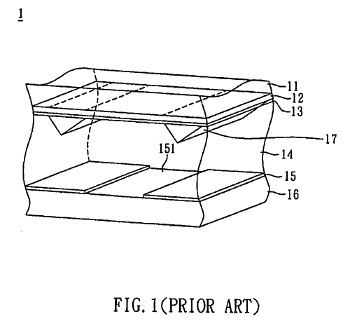

FIG. 2 is a schematic illustration showing another conventional LCD apparatus;

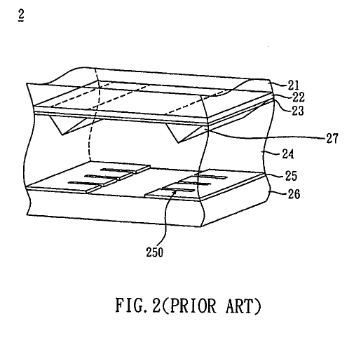

FIG. 3 is a schematic illustration showing a LCD apparatus according to a first preferred embodiment of the invention;

FIG. 4 is a schematic illustration showing a first jagged pattern according to the first preferred embodiment of the invention;

FIG. 5 is a schematic illustration showing influences between the relative transmittance, the time and the condition, which includes the fine slit period S, the interval D1 and the width W1 fixed at 3 microns, according to the first preferred embodiment of the invention;

FIG. 6 is a schematic illustration showing influences between the relative transmittance, the time and the condition, which includes the fine slit period S, the interval D1 and the width W1 fixed at 2 microns, according to the first preferred embodiment of the invention;

FIG. 7 is a schematic illustration showing influences between the relative transmittance, the time and the condition, which includes the fine slit period S fixed at 5 microns, the interval D1 and the constant width W1, according to the first preferred embodiment of the invention;

FIG. 8 is a schematic illustration showing a relationship between the relative transmittance and the fine slit period according to the first preferred embodiment of the invention;

FIG. 9 is a schematic illustration showing a first jagged pattern being a feather-like pattern according to the first preferred embodiment of the invention;

FIG. 10 is a schematic illustration showing first fine slits staggered on the first main slit according to the first preferred embodiment of the invention;

FIG. 11 is a schematic illustration showing the first main slit intersecting with another first main slit according to the first preferred embodiment of the invention;

FIG. 12 is a schematic illustration showing that each of the first fine slits and the second fine slit do not overlap with each other according to the first preferred embodiment of the invention;

FIG. 13 is a schematic illustration showing that each of the first fine slits and the second fine slit overlap with each other according to the first preferred embodiment of the invention;

FIG. 14 is a schematic illustration showing that each of the first fine slits and the second fine slit interleave with each other according to the first preferred embodiment of the invention;

FIG. 15 is a schematic illustration showing a LCD apparatus according to a second preferred embodiment of the invention; and

FIG. 16 is a schematic illustration showing the common electrode and pixel electrode of the LCD apparatus according to the second preferred embodiment of the invention; and

FIG. 17 is a schematic illustration showing a LCD apparatus according to a third preferred embodiment of the invention.

### DETAILED DESCRIPTION OF THE INVENTION

The present invention will be apparent from the following detailed description, which proceeds with reference to the accompanying drawings, wherein the same references relate to the same elements.

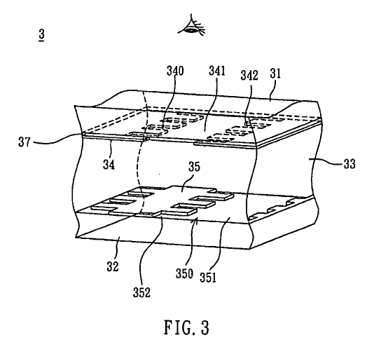

Referring to FIG. 3, a liquid crystal display (LCD) apparatus 3 according to the first preferred embodiment of the invention includes a first substrate 31, a second substrate 32, a liquid crystal (LC) layer 33, a common electrode 34 and a pixel electrode 35. In the embodiment, the LCD apparatus 3 is a multi-domain vertical aligned mode (MVA) LCD apparatus.

In this embodiment, the first substrate 31 and the second substrate 32 are disposed opposite to each other, and the LC layer 33 is disposed between the first substrate 31 and the second substrate 32. The LC layer includes a plurality of liquid crystal molecules. The tilt directions of the liquid crystal molecules are influenced by an electric field, which is generated when an external voltage is applied. When no electric field is applied to the LC layer, the liquid crystal molecules are substantially vertically arranged between the first substrate 31 and the second substrate 32.

In the embodiment, the common electrode 34 is disposed between the first substrate 31 and the LC layer 33, and is formed with at least one first jagged pattern 340 having a first main slit 341 and a plurality of first fine slits 342 disposed at both sides of the first main slit 341. In addition, the conductive material of the common electrode 34 may be, for example but not limited to, an indium-tin oxide (ITO), an indium-zinc oxide (IZO) or an aluminum-zinc oxide (AZO).

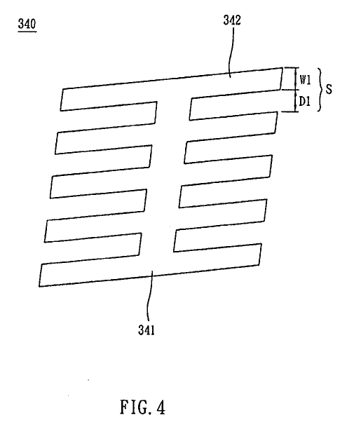

As shown in FIGS. 3 and 4, a sum S of a width W1 and an interval D1 between each first fine slit 342 and its adjacent first fine slit 342 is greater than or equal to 3 microns and smaller than 7 microns in the first jagged pattern 340 of this embodiment. Hereinafter, the sum S (wherein S=W1+D1) is referred to as a fine slit period S. The range is obtained according to the following experiments and manufacturing experiences.

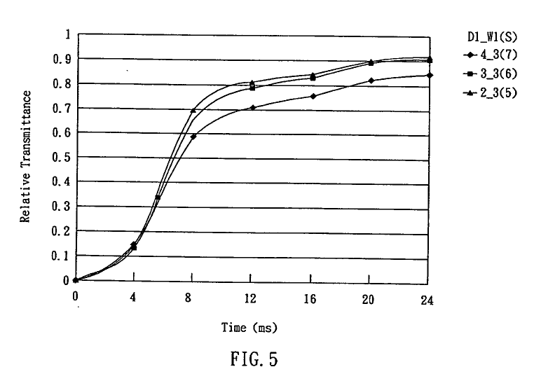

Referring to FIG. 5, the width W1 of each first fine slit 342 is fixed in this embodiment, and the width W1 of each first fine slit 342 of the first jagged pattern 340 and the fine slit period S (denoted by D1_W1(S) in FIG. 5) are observed to find out the influences on the relative transmittance (based on the maximum brightness that can be reached by the pixel itself) and the response time of the liquid crystal molecule. The response time is defined as the time for the liquid crystal molecule to rotate to the position capable of reaching the transmittance of 0.9 when the liquid crystal molecule is influenced by the electric field and the first jagged pattern 340.

As shown in FIG. 5, when the fine slit periods S are 5, 6 and 7 microns and the widths W1 of the first fine slits 342 are fixed at 3 microns, the response times are respectively 20 milliseconds, 20.5 milliseconds and greater than 24 milliseconds. According to the experimental result, it is obtained that the response time of the liquid crystal molecule is shorter as the value of the fine slit period S is smaller.

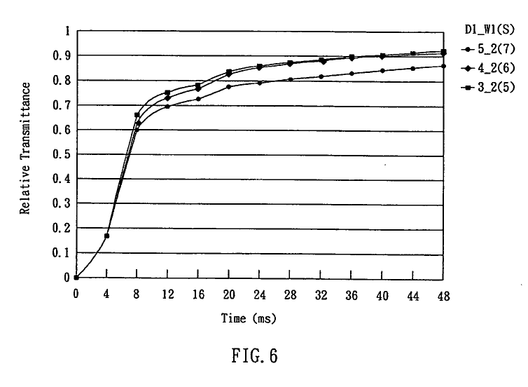

Next, as shown in FIG. 6, when the fine slit periods S are equal to 5, 6 and 7 microns and the widths W1 of the first fine slits 342 are fixed at 2 microns, the response times are respectively 37 milliseconds, 40 milliseconds and greater than 48 milliseconds. Thus, it can be further verified that the response time of the liquid crystal molecule tends to become shorter as the value of the fine slit period S becomes smaller according to the experimental result. Compared the curve 3_2(5) of FIG. 6 with the curve 3_3(6) of FIG. 5, it can be found that the response time for the liquid crystal molecule to reach the predetermined level is shorter as the width W1 of the first fine slit 342 becomes larger when the interval D1 between the first fine slit 342 and another first fine slit 342 is fixed. In addition, the fine slit periods S in FIGS. 5 and 6 are the same as each other and the width W1 of the first fine slit 342 of FIG. 5 is greater than the width W1 of the first fine slit 342 of FIG. 6 (W1=3 in FIG. 5; and W1=2 in FIG. 6). Therefore, it can be derived that the response time for the liquid crystal molecule to reach the predetermined level becomes shorter when the width W1 of the first fine slit 342 becomes greater.

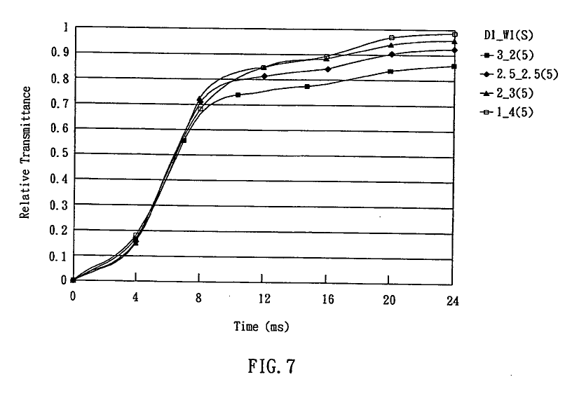

In addition, as shown in FIG. 7, when the fine slit periods S are fixed at 5 microns and the widths W1 of the first fine slits 342 are respectively 4, 3, 2.5 and 2 microns, the response times for the liquid crystal molecules are respectively 17, 18, 20 and greater than 24 milliseconds. It is further proved that the response time for the liquid crystal molecule becomes shorter as the width W1 of the first fine slit 342 gets larger when the fine slit period S is fixed according to the experimental results.

When the width W1 of the first fine slit 342 is smaller than 2 microns, a lot of time must be spent for the liquid crystal molecule to reach the predetermined level, thereby lengthening the response time. The reason will be described in the following. When the width W1 of the first fine slit 342 is smaller than 2 microns, the distance between two first fine slits 342 disposed on both sides of the interval is very small (i.e., smaller than 2 microns). Thus, the distortion of the electric field is reduced and the tilt direction of the liquid crystal molecule on the boundary of the first fine slit is indefinite. When a voltage is instantaneously applied from the outside, the liquid crystal molecule tilts in an arbitrary direction to cause the disclination. When the liquid crystal molecule wants to retilt to the correct direction, the time is thus lengthened. That is, the response time of the liquid crystal molecule is lengthened, so the width W1 of the first fine slit 342 has to be greater than or equal to 2 microns.

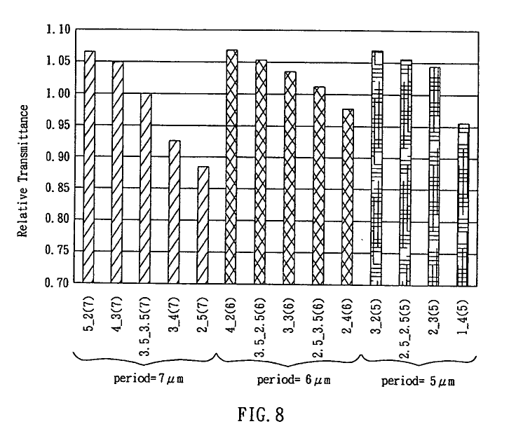

FIG. 8 shows the relationship between the relative transmittance and the fine slit period based on the curve 3.5_3.5(7). As shown in the curve 1_4(5) of FIG. 8, the brightness is decreased a lot when the interval D1 between the first fine slit 342 and its adjacent first fine slit 342 is smaller than 1 micron. Thus, the interval D1 between the first fine slits 342 has to be preferably greater than or equal to 1 micron. In the practical production machine, the limitation of the slit that can be manufactured is also about 1 micron. In addition, it can be derived that the response time for the liquid crystal molecule to reach the predetermined level is shorter when the width W1 of the first fine slit 342 gets larger according to FIGS. 5 and 6. However, it is found that the relative transmittance of the liquid crystal molecule tends to decrease when the width W1 of the first fine slit 342 becomes larger according to the experimental result of FIG. 8. Thus, the width W1 of the first fine slit 342 cannot be unlimitedly increased.

By summing up the above-mentioned experimental results, decreasing the fine slit period S can shorten the response time. At present, the slit period of the product is 7 microns. Thus, the fine slit period S should be smaller than 7 microns in this embodiment. The fine slit period S is a sum of the width W1 of the first fine slit 342 and the interval D1 between the first fine slit 342 and its adjacent first fine slit 342 (S=W1+D1). In addition, the interval D1 between the adjacent first fine slits 342 has no great influence on the response time of the liquid crystal molecule. At present, the minimum interval D1 for the reasonable manufacturing process is about 1 micron. However, the width W1 of the first fine slit 342 has to be greater than or equal to 2 microns. Thus, the sum of the width W1 of each first fine slit 342 of the first jagged pattern 340 in the common electrode 34 and the interval D1 between the first fine slit 342 and its adjacent first fine slit 342 is greater than or equal to 3 microns and smaller than 7 microns in order to shorten the response time of the liquid crystal molecule in this embodiment.

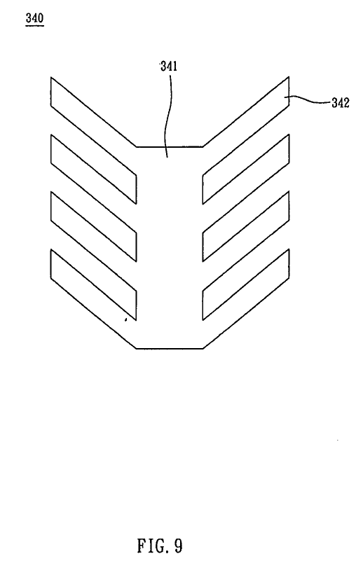

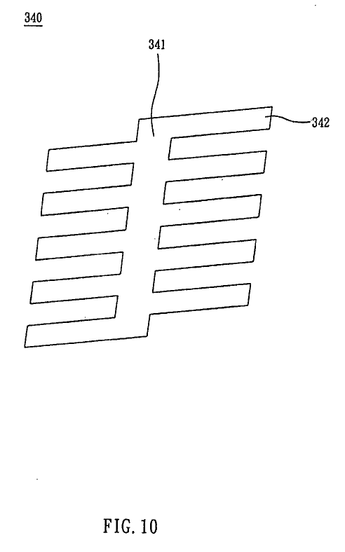

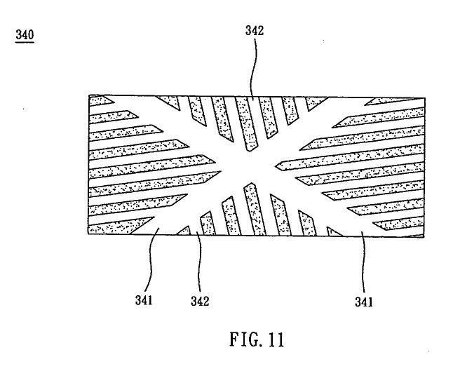

In the embodiment, the implementation of the first jagged pattern 340 is not particularly restricted, and the first jagged pattern 340 may be a feather-like pattern (as shown in FIG. 9), a fork-like pattern (as shown in FIG. 10) or a snowflake-like pattern (as shown in FIG. 11). Therefore, the arrangement of the first fine slits 342 is not particularly restricted, and the first fine slits 342 may be arranged symmetrically (as shown in FIG. 4), or may be staggered (as shown in FIG. 10), and are disposed at both sides of the first main slit 341. In addition, as shown in FIG. 11, the first main slit 341 may intersect with another first main slit 341 to form another aspect of the first jagged pattern 340.

As shown in FIG. 3, the pixel electrode 35 is disposed between the second substrate 32 and the LC layer 33, and is disposed opposite to the common electrode 34. The conductive material of the pixel electrode 35 is, for example but not limited to, ITO, IZO or AZO.

In addition, the pixel electrode 35 may be formed with one or more second jagged patterns 350. Each second jagged pattern 350 has a second main slit 351 and a plurality of second fine slits 352 disposed at both sides of the second main slit 351. The sum of the width of each second fine slit 352 and the interval between the second fine slit 352 and its adjacent second fine slit 352 is greater than or equal to 3 microns and smaller than 7 microns. The second jagged pattern 350 of this embodiment and the above-mentioned first jagged pattern 340 have the same features, functions and aspects, so detailed descriptions thereof will be omitted.

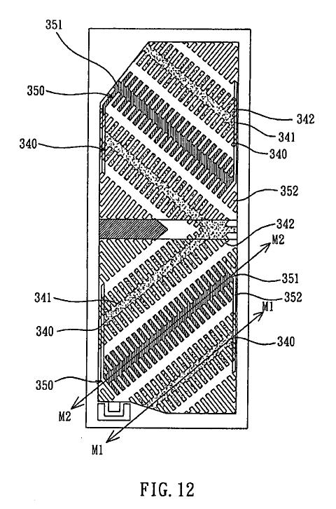

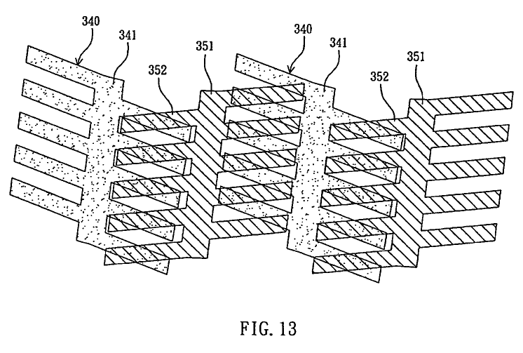

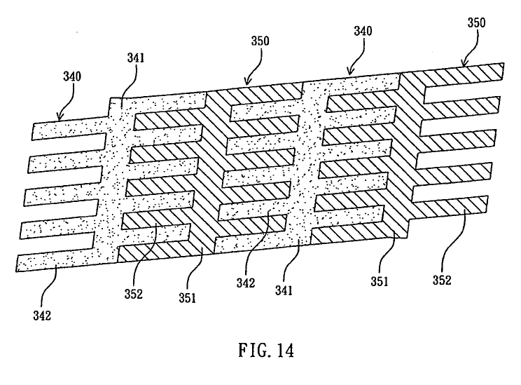

The implemented arrangement of the first jagged pattern 340 and the second jagged pattern 350, viewed at a location above the drawing sheet of FIG. 3, is not particularly restricted. However, the main slits may be parallel along the vertical direction (the straight line M1-M1 and the straight line M2-M2 are parallel to each other in FIG. 12), and the first fine slits 342 and the second fine slits 352 may not overlap (see FIG. 12), may overlap (see FIG. 13), or may interleave with each other (see FIG. 14).

The liquid crystal molecule is influenced by the first jagged pattern 340 and the second jagged pattern 350 so as to generate the tilt angle. When the sum of the width of the fine slit and the interval between the adjacent fine slits is greater than or equal to 3 microns and smaller than 7 microns, the fringe-field effects of the liquid crystal molecules corresponding to the first fine slit 342 and the second fine slit 352 farther from the first main slit 341 and the second main slit 351 can be increased, respectively, as the interval gets larger. Therefore, when an external voltage is applied, the tilt direction of the liquid crystal molecule can be easily controlled, the disclination phenomenon of the liquid crystal molecule can be avoided, and the response time of the liquid crystal molecular can be shortened. In addition, the widths of the first main slit 341 and the second main slit 351 can be increased because the widths of the first main slit 341 and the second main slit 351 cannot influence the response time or transmittance of the liquid crystal molecule. This manner can increase the ratio of the light-permeable region (i.e., the aperture ratio), and can further enhance the quality of the LCD apparatus.

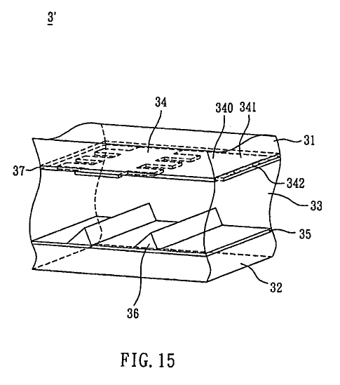

FIG. 15 is a schematic illustration showing a LCD apparatus 3′ according to a second preferred embodiment of the invention. As shown in FIG. 15, the difference between the first and second embodiments is that the pixel electrode 35 of the LCD apparatus 3′ of the embodiment is not formed with slits. Instead, at least one protrusion 36 is formed on the pixel electrode 35. When there are many protrusions 36 formed on the pixel electrode 35, each protrusion 36 is disposed opposite to the first jagged pattern 340.

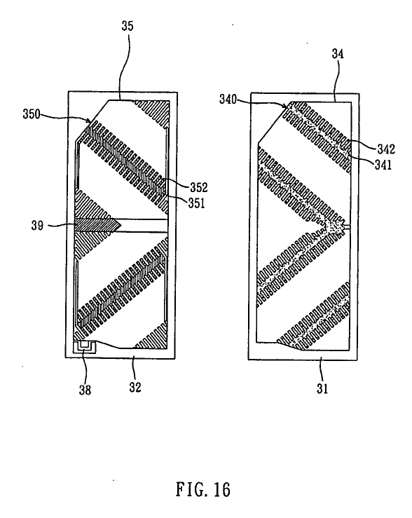

As shown in FIGS. 3, 15 and 16, the LCD apparatus 3′ of this embodiment further includes a color filter layer 37, at least one thin film transistor (TFT) 38 and a storage capacitor 39. The color filter layer 37 is disposed between the first substrate 31 and the common electrode 34. The TFT 38 is disposed on the second substrate 32, and the common electrode 34 is not disposed on the first substrate 31 corresponding to the storage capacitor 39.

The storage capacitor 39 is disposed in an opaque region of the second substrate 32, so the liquid crystal molecules in this region do not have the display function. Therefore, the common electrode 34 is not disposed on the first substrate 31 corresponding to the storage capacitor 39. In this manner, the quality of the LCD apparatus 3′ cannot be influenced. In addition, because the common electrode 34 is not disposed in this region, the liquid crystal capacitance of each pixel can be decreased to shorten the time for charging the liquid crystal capacitor. Meanwhile, because the pixel electrode 35 is enlarged to increase the aperture ratio (i.e., the light transmission), the higher quality of the LCD apparatus 3′ can be obtained.

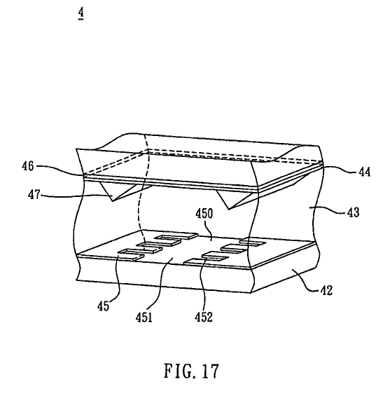

Referring to FIG. 17, a LCD apparatus 4 according to a third preferred embodiment of the invention includes a first substrate 41, a second substrate 42, a LC layer 43, a common electrode 44 and a pixel electrode 45.

What is different from the first preferred embodiment is that the third embodiment has at least one third jagged pattern 450, which is only formed on the pixel electrode 45, and disposed between the second substrate 42 and the LC layer 43. The third jagged pattern 450 has a third main slit 451 and a plurality of third fine slits 452 disposed at both sides of the third main slit 451. The sum of the width of each third fine slit 452 and the interval between the third fine slit 452 and its adjacent third fine slit 452 is greater than or equal to 3 microns and smaller than 7 microns.

The functions, features and aspects of the first substrate 41, the second substrate 42, the LC layer 43, the common electrode 44, the pixel electrode 45, the third jagged pattern 450 and the color filter layer 46 of the third embodiment are the same as those of the first substrate 31, the second substrate 32, the LC layer 33, the common electrode 34, the pixel electrode 35, the second jagged pattern 350 and the color filter layer 37 according to the first preferred embodiment (see FIG. 3), so detailed descriptions thereof will be omitted. Of course, the common electrode 44 may also be formed with a fourth jagged pattern or a protrusion 47, as shown in the drawing.

In summary, the LCD apparatus of the invention has the jagged pattern formed on the common electrode or the pixel electrode, and the jagged pattern has a main slit and a plurality of fine slits disposed at both sides of the main slit. Furthermore, the sum (fine slit period) of the width of each fine slit and the interval between the adjacent fine slits is greater than or equal to 3 microns and smaller than 7 microns. Compared with the related art, the LCD apparatus of the invention has the jagged pattern formed on the common electrode or the pixel electrode. The response time of the liquid crystal molecule gets shorter as the value of the fine slit period gets smaller. If the value of the interval between the fine slit and its adjacent fine slit is decreased, the response time of the liquid crystal molecule can be greatly shortened, and the fringe-field effects of the liquid crystal molecules corresponding to the fine slits of the first substrate and the second substrate farther from the main slits of the first substrate and the second substrate can be increased. Thus, when a voltage is applied, the tilt direction of the liquid crystal molecule can be easily controlled, and it is also possible to prevent the disclination of the liquid crystal molecule from happening. In addition, the fine slits on the first substrate and the second substrate can match with each other, so the fringe-field effects can be increased. Consequently, the interval between the main slits can be increased to increase the ratio of the light-permeable region, to increase the aperture ratio and thus to enhance the quality of the LCD apparatus.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A liquid crystal display (LCD) apparatus, comprising:
a first substrate;
a second substrate disposed opposite to the first substrate;
a liquid crystal (LC) layer disposed between the first substrate and the second substrate;
a common electrode disposed between the first substrate and the LC layer and formed with at least one first jagged pattern having a first main slit and a plurality of first fine slits disposed at both sides of the first main slit, wherein a sum of a width of each of the first fine slits and an interval between adjacent two of the first fine slits is greater than or equal to 3 microns and smaller than 7 microns; and
a pixel electrode disposed between the second substrate and the LC layer and located opposite to the common electrode.

2. The LCD apparatus according to claim 1, wherein the first fine slits are symmetrically disposed at the both sides of the first main slit, and the width of the first fine slit is greater than or equal to 2 microns.

3. The LCD apparatus according to claim 1, wherein the interval between the first fine slits is greater than or equal to 1 micron.

4. The LCD apparatus according to claim 1, wherein the pixel electrode is formed with at least one second jagged pattern having a second main slit and a plurality of second fine slits disposed at both sides of the second main slit, and a sum of a width of each of the second fine slits and an interval between adjacent two of the second fine slits is greater than or equal to 3 microns and smaller than 7 microns.

5. The LCD apparatus according to claim 4, wherein the second fine slits are symmetrically disposed at the both sides of the second main slit, and the width of the second fine slit is greater than or equal to 2 microns.

6. The LCD apparatus according to claim 4, wherein the interval between the second fine slits is greater than or equal to 1 micron.

7. The LCD apparatus according to claim 4, wherein the first jagged pattern and the second jagged pattern are parallel to each other along a vertical direction.

8. The LCD apparatus according to claim 7, wherein the first jagged pattern and the second jagged pattern do not overlap with each other, do overlap with each other or do interleave with each other along the vertical direction.

9. The LCD apparatus according to claim 1, further comprising:
at least one protrusion formed on the pixel electrode.

10. The LCD apparatus according to claim 9, wherein when there are a plurality of the protrusions formed on the pixel electrode, the protrusions are disposed opposite to the first jagged pattern.

11. The LCD apparatus according to claim 1, further comprising a storage capacitor, wherein the common electrode is not disposed on the first substrate corresponding to the storage capacitor.

12. A liquid crystal display (LCD) apparatus, comprising:
a first substrate;
a second substrate disposed opposite to the first substrate;
a liquid crystal (LC) layer disposed between the first substrate and the second substrate;
a common electrode disposed between the first substrate and the LC layer; and
a pixel electrode disposed between the second substrate and the LC layer and located opposite to the common electrode, wherein the pixel electrode is formed with at least one third jagged pattern having a third main slit and a plurality of third fine slits disposed at both sides of the third main slit, and a sum of a width of each of the third fine slits and an interval between adjacent two of the third fine slits is greater than or equal to 3 microns and smaller than 7 microns.

13. The LCD apparatus according to claim 12, wherein the third fine slits are symmetrically disposed at the both sides of the third main slit, and the width of the third fine slit is greater than or equal to 2 microns.

14. The LCD apparatus according to claim 12, wherein the interval between the third fine slits is greater than or equal to 1 micron.

15. The LCD apparatus according to claim 12, wherein the pixel electrode is formed with at least one fourth jagged pattern having a fourth main slit and a plurality of fourth fine slits disposed at both sides of the fourth main slit, and a sum of a width of each of the fourth fine slits and an interval between adjacent two of the fourth fine slits is greater than or equal to 3 microns and smaller than 7 microns.

16. The LCD apparatus according to claim 15, wherein the fourth fine slits are symmetrically disposed at the both sides of the fourth main slit, and the width of the fourth fine slit is greater than or equal to 2 microns.

17. The LCD apparatus according to claim 15, wherein the interval between the fourth fine slits is greater than or equal to 1 micron.

18. The LCD apparatus according to claim 15, wherein the third jagged pattern and the fourth jagged pattern are parallel to each other along a vertical direction.

19. The LCD apparatus according to claim 18, wherein the third jagged pattern and the fourth jagged pattern do not overlap with each other, do overlap with each other or do interleave with each other along the vertical direction.

20. The LCD apparatus according to claim 12, further comprising:
at least one protrusion formed on the common electrode.

21. The LCD apparatus according to claim 20, wherein when there are a plurality of the protrusions formed on the common electrode, the protrusions are disposed opposite to the third jagged pattern.

22. The LCD apparatus according to claim 12, further comprising a storage capacitor, wherein the common electrode is not disposed on the first substrate corresponding to the storage capacitor.
